(19) United States
(12) Patent Application Publication
(10) Pub. No.: US 2013/0081991 A1
(43) Pub. Date: Apr. 4, 2013

(54) CARBON FILM COMPOSITE, METHOD FOR PRODUCING SAME, AND SEPARATION MEMBRANE MODULE

(71) Applicant: KYOCERA CORPORATION, Kyoto-shi (JP)

(72) Inventors: Kenichi ITO, Kirishima-shi (JP); Kazuya MURAMOTO, Kirishima-shi (JP)

(73) Assignee: KYOCERA CORPORATION, Kyoto-shi (JP)

(21) Appl. No.: 13/686,690

(22) Filed: Nov. 27, 2012

Related U.S. Application Data
(63) Continuation-in-part of application No. PCT/JP2011/057838, filed on Mar. 29, 2011.

(30) Foreign Application Priority Data
May 27, 2010 (JP) 2010-121707
Oct. 26, 2010 (JP) 2010-239795

(51) Int. Cl. B01D 71/02

(52) U.S. Cl. CPC B01D 71/021
USPC 210/321.72; 427/228; 428/319.1; 210/506; 96/11

(57) ABSTRACT

A carbon film composite, separation membrane module, and a method of manufacturing are presented. A carbon film is on a surface of a porous substrate, and the carbon film has an R value of not less than about 0.840. The R value is calculated from a Raman spectrum of the carbon film.

### CROSS-REFERENCE TO RELATED APPLICATION

The present application is a continuation in part based on PCT Application No. JP2011/057838, filed on Mar. 29, 2011, which claims the benefit of Japanese Application No. 2010-121707, filed on May 27, 2010, and Japanese Application No. 2010-239795, filed on Oct. 26, 2010 both entitled “CARBON FILM COMPOSITE, METHOD FOR PRODUCING SAME, AND SEPARATION MEMBRANE MODULE”. The contents of which are incorporated by reference herein in their entirety.

### FIELD

The present disclosure relates generally to a carbon film composite, a method for producing same, and a separation membrane module, and in particular relates to a carbon film composite, a method for producing same, and a separation membrane module which are useful in a context of dehydrative concentration of water-containing alcohols.

### BACKGROUND

Separation membrane modules provided with fluid separation membranes capable of causing selective permeation and separation of a specific liquid (or gas) from a mixed liquid (or mixed gas) that contains a plurality of fluids have been known conventionally. The fluid separation membranes employed have comprised high-molecular-weight polymer membranes made from organic resin and the like, and have comprised inorganic membranes made from zeolite, glass, silica, and the like.

### SUMMARY

A carbon film composite, separation membrane module, and a method of manufacturing are presented. A carbon film is on a surface of a porous substrate, and the carbon film has an R value of not less than about 0.840. The R value is calculated from a Raman spectrum of the carbon film.

In an embodiment, a carbon film composite comprises a porous substrate, and a carbon film on a surface of the porous substrate. The carbon film has an R value of not less than about 0.840. The R value is calculated from a Raman spectrum of the carbon film.

In another embodiment, a method for manufacturing a carbon film composite applies a carbon film precursor solution to a surface of a porous substrate to form a resultant substrate. The method further subjects the resultant substrate to a first heat treatment in a non-oxidizing environment. The first heat treatment comprises increasing a temperature at a temperature rise rate in a range of about 10° C./min to about 50° C./min to reach a maximum temperature in a range of about 750° C. to about 950° C.

In a further embodiment, a separation membrane module comprises a carbon film composite, a mixed fluid feed chamber, and a separated fluid chamber. The carbon film composite comprises a carbon film side and a porous substrate side, and separates a component having a molecular diameter which is small enough to permeate the carbon film from a mixed fluid supplied to the carbon film side. The mixed fluid feed chamber supplies the mixed fluid to the carbon film side. The separated fluid chamber receives a fluid comprising the component, going through the carbon film composite, and coming out of the porous substrate side.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention are hereinafter described in conjunction with the following figures, wherein like numerals denote like elements. The figures are provided for illustration and depict exemplary embodiments of the invention. The figures are provided to facilitate understanding of the invention without limiting the breadth, scope, scale, or applicability of the invention. The drawings are not necessarily made to scale.

FIG. 1 is an illustration of an exemplary schematic sectional diagram of a carbon film composite according to an embodiment of the disclosure.

FIG. 2 is an illustration of a graph showing relationship between R value and separation factor α.

FIG. 3 is an illustration of a graph showing results of Raman spectroscopy.

FIG. 4 is an illustration of an exemplary schematic sectional diagram of a separation membrane module according to an embodiment of the disclosure.

FIG. 5 is a Table 1 showing exemplary experimental results obtained during first heat treatment of a carbon film composite according to an embodiment of the disclosure.

FIG. 6 is a Table 2 showing exemplary experimental results obtained during first and second heat treatment of a carbon film composite according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one non-limiting application, namely, a carbon film composite that separates water and ethanol. Embodiments of the disclosure, however, are not limited to such water and ethanol separation applications, and the techniques described herein may be utilized in other applications. For example, embodiments may be applicable to water and methanol separation, or other molecular separation.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

Separation membranes comprising carbon may comprise water resistance and chemical resistance properties, and excellent gas permeability characteristics. Carbon film composites in which various intermediate layers are made to intervene between a porous substrate and the carbon film allow fabricating a carbon film in thin and defect-free fashion, but may have low separation factors. Embodiments of the disclosure can enhance separation.

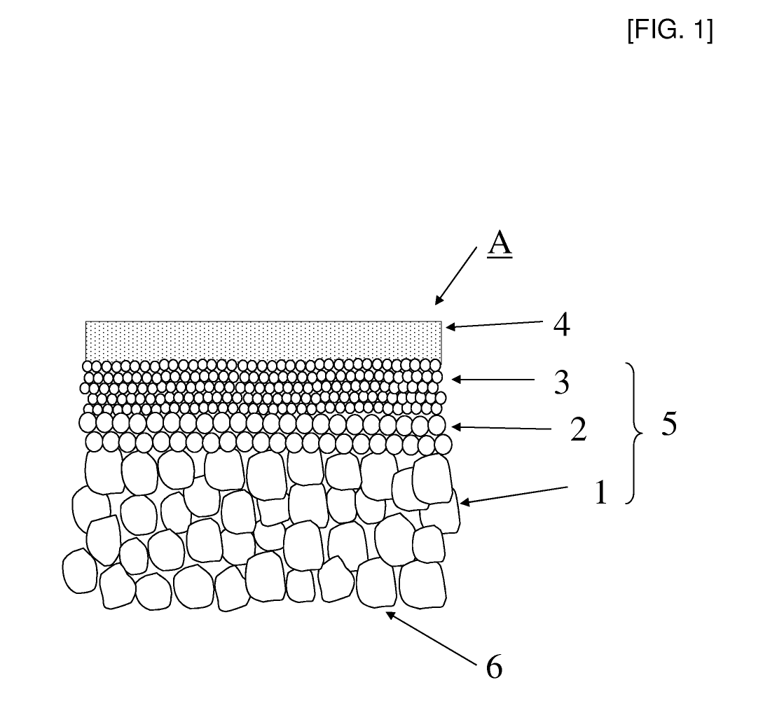

FIG. 1 is an illustration of an exemplary schematic sectional diagram of a carbon film composite A according to an embodiment of the disclosure. The carbon film composite A separates water and ethanol, and is presented as an example of an embodiment of a carbon film composite in accordance with an embodiment of the disclosure. The carbon film composite A shown in FIG. 1 comprises a porous substrate 5 and a carbon film 4. The porous substrate 5 comprises a porous body 1, an intermediate layer 2, an intermediate layer 3. The porous body 1 is made from a ceramic substance. The intermediate layer 2 and the intermediate layer 3 each comprises ceramic particles. The carbon film 4 comprises glassy carbon. Arranged in order from a bottom 6 of the carbon film composite A are: porous body 1, intermediate layer 2, intermediate layer 3, and the carbon film 4. In this manner, the porous body 1 is located at the bottom 6 and is coupled to the intermediate layer 2. The intermediate layer 2 is coupled to the intermediate layer 3, and the intermediate layer 3 is coupled to the carbon film 4.

The porous body 1 may comprise material such as, but without limitation, alumina, mullite, cordierite, zirconia, magnesia, silicon carbide, silicon nitride, and/or other ceramic substance. Employing such ceramic substance(s) as a material for the porous body 1 makes possible improving a difference in thermal expansion between the porous body 1 and the intermediate layer 2, the intermediate layer 3, and the carbon film 4, and to improve heat resistance, mechanical strength, wear resistance, thermal shock resistance, chemical resistance, and corrosion resistance. While two intermediate layers comprising the intermediate layer 2, the intermediate layer 3 are shown as being fabricated in FIG. 1, it is also possible to employ a single intermediate layer or to employ three or more intermediate layers.

An average diameter of ceramic particles forming the porous body 1 may comprise, for example but without limitation, about 1 μ to about 10 μ, about 1 μ to about 5 μ, or other suitable range. Causing an average particle diameter of the ceramic particles to be within such a range makes possible maintaining a high mechanical strength at the porous body 1. An average particle diameter of the ceramic particles forming the porous body 1 may be determined by, for example, an intercept method from sectional photograph(s) of the porous body 1 obtained using scanning electron microscopy (SEM).

A porosity of the porous body 1 may comprise, for example but without limitation, about 30% to about 60%, about 30% to about 50% or other suitable range. Causing porosity to be within such a range makes possible increasing a permeation rate of a fluid which may comprise gas or liquid (e.g., water) and to maintain high mechanical strength at the porous body 1. Porosity of the porous body 1 may be determined using a mercury intrusion method as an example.

The intermediate layer 2 and the intermediate layer 3 may comprise particles such as, but without limitation, alumina, carbon, or other particle. Average particle diameter of each of the intermediate layer 2 and the intermediate layer 3 is less than average particle diameter of the ceramic particles which forms the porous body 1. Average particle diameter of each of the intermediate layer 2 and the intermediate layer 3 may be, for example but without limitation, less than about 1.0 μ, and not more than about 0.5 μ. Average particle diameters of the particles which form, the porous body 1, the intermediate layer 2, and the intermediate layer 3 are such that average particle diameter is largest for the porous body 1. Average particle diameter decreases in the order: intermediate layer 2, intermediate layer 3. In this manner, average particle diameter of the intermediate layer 2 is larger than average particle diameter of the intermediate layer 3.

The carbon film 4 is formed on a surface of the intermediate layer 3. The carbon film 4 comprises glassy carbon. Glassy carbon is defined as carbon having uniform external appearance, with no grain boundaries or other such internal structure, as viewed under optical microscopy, this being substantially different from granular carbon. In the present disclosure, a glassy carbon is defined as a substance which comprises a multiplicity of fine micropores at an interior thereof and which displays a molecular sieve effect. Molecules that are in diameter small enough to permeate the carbon film 4 will permeate the micropores of the glassy carbon forming the carbon film 4. In the present embodiment, composite layer(s) may be present at interface(s) between the carbon film 4 and a porous substrate 5. The composite layer(s) comprises carbonaceous materials(s) and a ceramic layer(s) comprising the carbonaceous materials(s) at the interior(s) thereof. As the ceramic layer(s), at least one portion of the same layer as the intermediate layer 3, the intermediate layer 2, the porous body 1 may be used. The carbonaceous materials(s) may be a glassy carbon and so forth and/or other such carbonaceous materials(s).

The carbon film 4 may comprise, for example but without limitation, about 0.01 μ to about 5 μ in thickness, about 0.1 μ to about 3 μ in thickness, or other suitable thickens. Causing a thickness to be within such range makes possible suppression of occurrence of pinholes and other such defects and increased permeation rate.

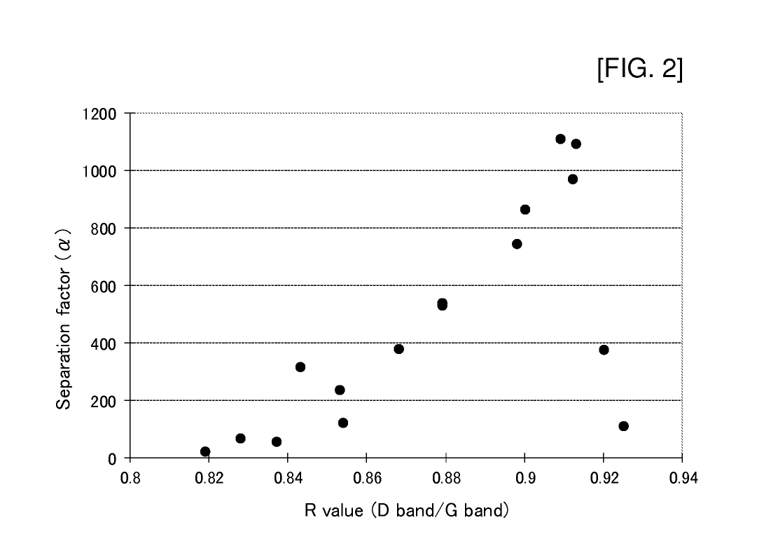

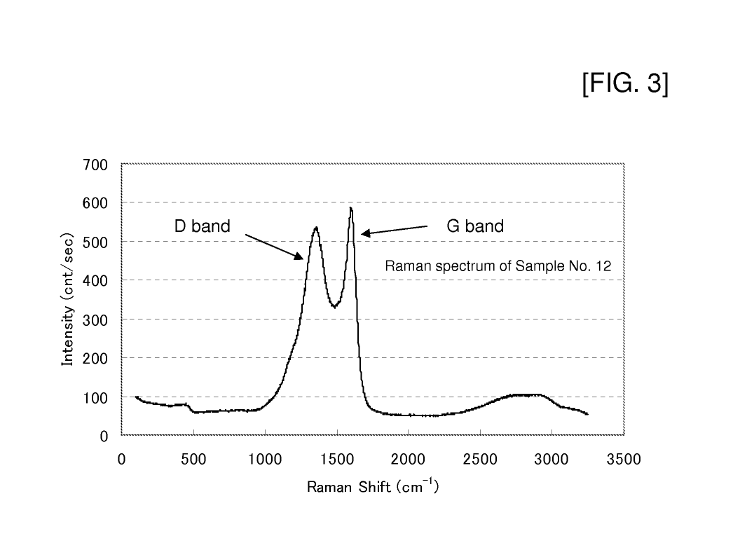

The carbon film composite A of the present embodiment is such that the R value (D band peak intensity divided by G band peak intensity) calculated from the Raman spectrum (e.g., laser wavelength=about 514.3 nm) of the carbon film 4 may be, for example but without limitation, not less than about 0.840, about 0.860 to about 0.915, and about 0.870 to about 0.915, or other suitable value. Causing R value of the carbon film 4 to be not less than 0.840 will make it possible to increase separation factor α and to obtain the carbon film composite A having a high permeation rate Q. The relationship between R value and separation factor α is shown in FIG. 2, and the results of the Raman spectroscopy are shown in FIG. 3.

A large separation factor α for separation of water and ethanol may be obtained when the R value of the carbon film 4 is about 0.840 or higher. For carbon materials, an increase in the R value generally signifies disordering of graphitic structure and decrease in crystallite size. While carbon film 4 comprises an amorphous structure, the microstructure thereof may be of lamellar amorphous configuration with layering of multiple graphene sheets, and the size of the lamellar amorphous configuration may correspond to a crystallite size. Micropores within the carbon film 4 that separate water and ethanol may correspond to intercrystallite voids. In some embodiments, the smaller the crystallite size, the smaller will be the intercrystallite voids, and thus the smaller will be the micropores of the carbon film 4, with selective permeation of water therethrough causing an increase in separation factor α.

For example, a micropore diameter may be suited for causing occurrence of a molecular sieve effect for separation of water from a mixed fluid comprising at least two fluids such as water and ethanol, and thus increasing separation factor α, when carbon film 4 comprises an R value that is not less than about 0.840, about 0.860 to about 0.915, about 0.870 to about 0.915, or other suitable value. The mixed fluid, may comprise, for example but without limitation, at least two gases, at least two liquids, water and ethanol, water and methanol, or other mixed fluid.

Alternatively, when the R value of the carbon film 4 is about 0.915 or higher, while a decrease in both permeation rate Q and separation factor α in accompaniment to increase in R value may cause a decrease in intercrystallite voids at the carbon film 4 overall, there may be local presence of micropores of such size as to permit permeation of ethanol molecules therethrough due to activation or the like. What is meant here by activation refers to a phenomenon whereby micropores are generated within a structure due to reaction between carbon film 4 and gases (H₂O, CO, CO₂) liberated during high-temperature heat treatment of the carbon film 4.

In some embodiment, when R value is below about 0.840, a large diameter at the micropores within the carbon film 4 causes an increase in a number of ethanol molecules which permeate therethrough, and that this causes a decrease in separation factor α.

The carbon film 4 may contain oxygen. Presence of oxygen within the carbon film 4 in the form of hydroxyl groups (OH), carboxyl groups (COON), or other such hydrophilic functional groups improves affinity between carbon film 4 and separated component(s), e.g., water molecules, carbon dioxide molecules, or the like, that permeate the carbon film 4. This makes possible further improving a transfer rate of separated component(s) within the carbon film 4, and achieving a higher separation factor while maintaining a high permeation rate.

The amount of oxygen contained in the carbon film 4 may be confirmed by elemental analysis. For example, x-ray fluorescence analysis, wavelength dispersive x-ray spectrometry (WDS), energy dispersive x-ray spectrometry (EPS), or the like may be employed. Analysis of the C—O bond may be carried out using x-ray photoelectron spectroscopy (XPS). Here, separation factor α and permeation rate Q for a solution containing a mixture of water and ethanol may be defined according to the following formulas.

Separation factor α=(P_{H2O}/P_{EtOH}) / (F_{H2O}/F_{EtOH}) Formula 1

Where:

P_{H2O}=Concentration by mass of water at the permeate side of the carbon film composite (mass %);

P_{EtOH}=Concentration by mass of ethanol at the permeate side of the carbon film composite (mass %);

F_{H2O}=Concentration by mass of water at the feed side of the carbon film composite (mass %); and

F_{EtOH}=Concentration by mass of ethanol at the feed side of the carbon film composite (mass %).

Permeation rate Q=P/(S×T) Formula 2

Where,

P=Amount of water/ethanol solution that permeates the carbon film composite (kg);

S=Surface area of carbon film layer at carbon film composite (m²); and

T=Number of hours that pervaporative measurement was carried out (h).

During measurement of pervaporative separation, concentration by mass (mass %) of water and ethanol at the feed side and at the permeate side may, for example, be measured using a GC-2014 Gas Chromatograph (Shimadzu Corporation). Measurement of pervaporation may be carried out by applying atmospheric pressure to the feed side (outside of the carbon film 4), applying a vacuum to the permeate side (inside of the carbon film 4), and using the difference in pressure as driving force to cause a solution containing a mixture of water and ethanol (mostly water) which is present at the outside of the carbon film 4 to permeate therethrough toward the inside of the carbon film 4.

To determine R value, the peak intensities of the G band (in the vicinity of 1590 cm⁻¹) and the D band (in the vicinity of 1350 cm⁻¹) in the spectrum obtained by Raman spectroscopy are first recorded. Next, the R value is determined by calculating the ratio of the peak intensity of the D band to the peak intensity of the G band (D band peak intensity divided by G band peak intensity).

The carbon film composite A comprising constitution as described above may be fabricated as follows. The porous body 1, which is made from a ceramic substance, is first prepared. Ceramic particles, e.g., alumina particles, for formation of the intermediate layer 2 are dispersed within solvent to form a slurry. The porous body 1 is immersed within this slurry to form a coating that will become the intermediate layer 2 on the surface of porous body 1, and the coating is dried at prescribed temperature.

Next, ceramic particles, e.g., alumina particles, for formation of the intermediate layer 3 are dispersed within solvent to form a slurry, and the porous body 1 is immersed within this slurry. A coating that will become the intermediate layer 3 is formed on the surface of the coating that will become the intermediate layer 2 on the surface of porous body 1, and the coating is dried at prescribed temperature to obtain the porous substrate 5.

Next, dip coating (immersion coating) or other such application method is used to apply carbon film precursor solution, in which carbon film precursor is dissolved in solvent, to the surface of the intermediate layer 3 of the porous substrate 5, and this is dried. The carbon film precursor is subjected to heat treatment in a nonoxidizing environment to cause carburization (first heat treatment) and obtain carbon film composite A. As carbon film precursor, aromatic polyimides, polypyrrolone, polyfurfuryl alcohol, polyvinylidene chloride, phenolic resins, and the like may be employed. Favorably employed among these are phenolic resins.

A reason for this is that, because phenolic resins contain many hydrophilic functional groups, there is a tendency for water to be adsorbed by OH groups that remain following carburization, and for surface diffusion to cause the water to penetrate the micropores of the carbon film 4. The conditions under which the first heat treatment takes place are such that heat treatment temperature is about 750° C. to about 950° C., and temperature rise rate is about 10° C./min to about 50° C./min. In particular, it is preferred that heat treatment temperature be about 800° C. to about 900° C. This make possible forming the carbon film 4 having a micropore diameter that is substantially optimal for separation of water.

The carbon film composite A constituted as described above comprises water resistance and chemical resistance so as to permit the carbon film 4 to function as a separation membrane. Because the R value as calculated from the Raman spectrum of about carbon film 4 is not less than about 0.840, it is possible to obtain the a carbon film composite A having the carbon film 4 that exhibits a high separation factor α during separation of water and ethanol. In particular, when R value satisfies the condition that it be about 0.870 to about 0.915, it will be possible to obtain a carbon film composite A having the carbon film 4 that exhibits a high separation factor α and that also exhibits a high permeation rate Q during separation of water and ethanol.

The carbon film composite A of the present embodiment may be manufactured by applying carbon film precursor solution to the surface of the intermediate layer 3 of the porous substrate 5, drying this, and carrying out heat treatment at a temperature rise rate of about 10° C./min to about 50° C./min to reach a maximum temperature of about 750° C. to about 950° C. in a nonoxidizing environment or under vacuum conditions.

It is preferred that the surface at the porous body 1 side (porous substrate side 5) of the carbon film composite A which is obtained in this fashion be brought into contact with a gas containing ozone (O₃), and that the carbon film composite A thereafter be subjected to heat treatment (second heat treatment) under atmospheric conditions. Hydrophilic functional groups such as hydroxyl groups (OH), carboxyl groups (COON), and the like that are present within the carbon film precursor will ordinarily tend to be broken down during the course of the carburization that takes place during the first heat treatment.

It may therefore often be the case that there are a small amount of hydrophilic functional groups present within the carbon film 4 and that there is little contribution on the part thereof to promotion of transport of separated components. Bringing the surface at the porous body 1 side of carbon film composite A into contact with a gas containing O₃ causes O₃ to be adsorbed by the carbon film 4 by way of the pores of the porous substrate 5. Subjecting this carbon film composite A to heat treatment under atmospheric conditions causes reaction to occur between the carbon film 4 and O₃, and makes it possible to impart the micropore walls at the carbon film 4 with OH groups, COOH groups, and other such hydrophilic functional groups. As a result, achieving an even higher separation factor α possible. For this carbon film composite A, oxygen content within the carbon film 4 is greater in the vicinity/near of the intermediate layer 3 side of the carbon film 4 than in the vicinity/near of the surface side of the carbon film 4.

When the carbon film composite A comprises composite layer(s) comprising ceramic layer(s) and carbonaceous materials(s) at interface(s) between the carbon film 4 and the intermediate layer 3, carbonaceous materials(s) within composite layer(s) may similarly be imparted with functional groups as a result of reaction with O₃. Oxygen content of carbonaceous materials(s) within composite layer(s) is greater than oxygen content of the carbon film 4. In particular, if pores are present within composite layer(s), because this will result in large surface area for adsorption of O₃, there will be even more marked effect in terms of increase in separation factor α.

To form pores within composite layer(s), carbon film precursor solution that contains pore-forming agent may, for example, be made to penetrate the interior of the porous substrate 5, with carbon film precursor solution that does not contain pore-forming agent thereafter being used to form the carbon film 4. Oxygen content of carbonaceous materials(s) that form composite layer(s) may be defined as net oxygen content calculated by subtracting the amount of oxygen present in ceramic particles from the amount of oxygen present in the composite layer(s) overall as obtained by carrying out elemental analysis thereon.

Conditions under which the surface at the porous body 1 side of carbon film composite A may be brought into contact with a gas containing O₃ are as follows. First, as the carbon film composite A, the porous body 1 which is tubular and which has an inside diameter of about 9 mm and a length of about 100 mm may, for example, be prepared. The intermediate layer 2, the intermediate layer 3, and the carbon film 4 would be formed on the outside surface of this tube. O₃ at a flow rate of about 4.0×10⁻³ mol/h to about 5.0×10⁻³ mol/h would be made to contact the surface at the inside of this tube for about 3 to about 7 hours. The temperature at which this takes place may be room temperature. As gas containing O₃, 100% O₃ may be used, or a gas mixture in which O₃ is mixed with nitrogen, argon, or other such carrier gas may be used.

The second heat treatment may, for example, thereafter be carried out for about 10 minutes to about 30 minutes at a temperature of about 150° C. to about 300° C. under atmospheric conditions. The carbon film composite A fabricated in this fashion will be such that oxygen is present at the carbon film 4, this oxygen content being greater in the vicinity/near the intermediate layer 3 side (near the porous substrate 5) of the carbon film 4 than it is in the vicinity/near of the surface side of the carbon film 4.

When the carbon film 4 side of carbon film composite A is brought into contact with a gas containing O₃ and glassy carbon at the surface of carbon film 4 is imparted with functional groups, there is a concern that formation of functional groups may cause decrease in micropore diameter at glassy carbon at the surface of the carbon film 4, and that permeation factor(s) of separated component(s) may decrease, and that this may interfere with permeation through the carbon film 4 of component(s) to be separated.

The R value calculated from the Raman spectrum of the carbon film 4 is said to be due to disordering of graphitic structure and decrease in crystallite size at the carbon film 4, and such phenomena should not change depending on whether functional groups are imparted thereto.

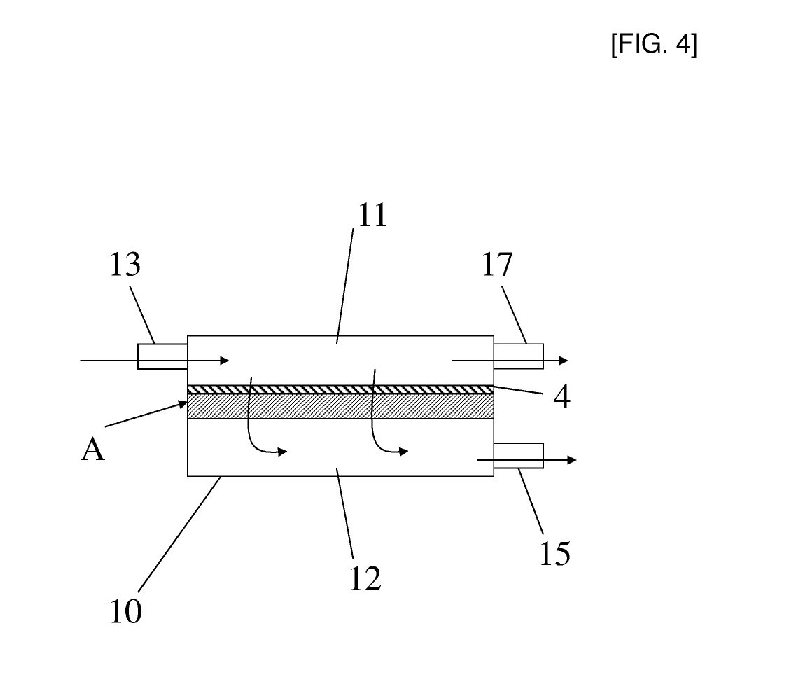

FIG. 4 is an illustration of an exemplary schematic sectional diagram of a separation membrane module according to an embodiment of the disclosure. As shown in FIG. 4, a separation membrane module is constituted such that the carbon film composite A is housed within a housing 10.

At such separation membrane module, housing the planar carbon film composite A within housing 10 causes a space at an interior of housing 10 to be divided into two chambers, these being mixed fluid feed chamber 11 and separated fluid chamber 12. The mixed fluid feed chamber 11 is a part thereof at which mixed fluid containing water and ethanol is supplied to the carbon film 4 side of the carbon film composite A. The separated fluid chamber 12 is a part thereof into which water and/or water vapor enters, after this water and/or water vapor, these being the molecules that are smallest in diameter among the molecules making up the mixed fluid at the mixed fluid feed chamber 11, permeate the carbon film 4 and are guided to the porous body 1 side thereof by way of the intermediate layers 2 and 3.

At the separation membrane module, mixed fluid containing water and ethanol is first supplied to the carbon film 4 side of the carbon film composite A within the mixed fluid feed chamber 11 by way of an inlet 13. Next, water and/or water vapor, these being molecules of small diameter, permeate the carbon film 4, are transported to the porous body 1 side thereof by way of the intermediate layers 2 and 3, and are guided into the separated fluid chamber 12.

Next, water and/or water vapor guided thereinto are made to exit therefrom via an outlet 15. On the other hand, ethanol, which has large molecular diameter and is unable to permeate the carbon film 4, is made to exit therefrom via a discharge port 17. Because there is a difference in a size of the molecular diameter of water molecules versus ethanol molecules, mixed fluid containing water and ethanol can be separated into water and into ethanol by such a separation membrane module.

The carbon film composite A may be, for example but without limitation, cylindrical, or other suitable shape Employment of the separation membrane module having a cylindrical carbon film composite A will make it possible to supply mixed fluid containing water and ethanol to the inside of this cylinder and to cause water to permeate therethrough to the outside of the cylinder. Alternatively mixed fluid containing water and ethanol may be supplied to the outside of the cylinder, and water may be made to permeate therethrough to the inside of the cylinder. At the separation membrane module, a partition may be used to partition the interior of the housing 10 into the mixed fluid feed chamber 11 and the separated fluid chamber 12, and a plurality of cylindrical carbon film composites A may be supported by and secured to this partition.

### EXAMPLES

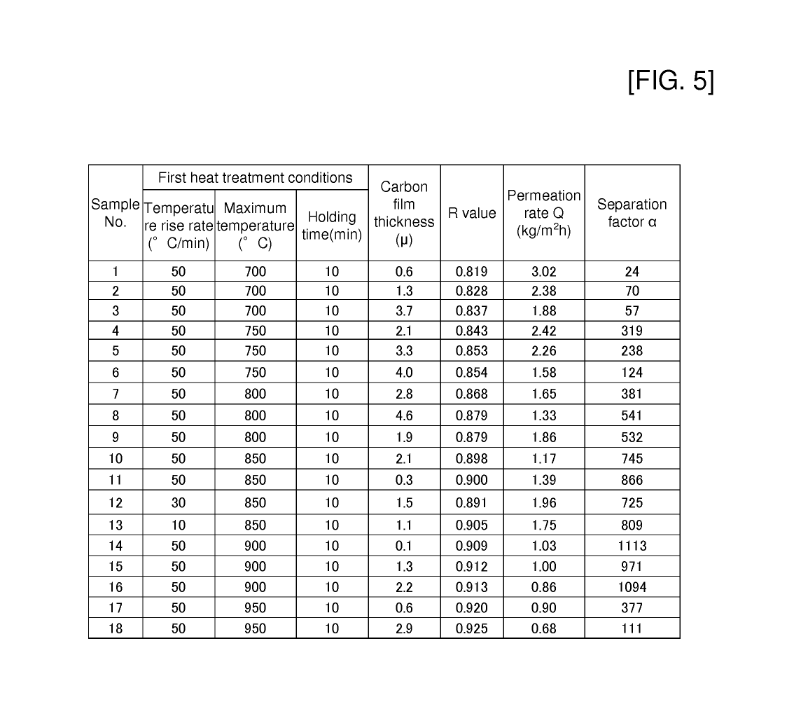

FIG. 5 is a Table 1 showing exemplary experimental results obtained during first heat treatment of a carbon film composite according to an embodiment of the disclosure. Powdered alumina (particle diameter 0.20 μ), this being raw material for intermediate layer 2, was dispersed within water and polyvinyl alcohol (PVA) to form a slurry. A porous alumina tube (outside diameter 12 mm; inside diameter 9 mm; length 100 mm; average micropore diameter 1.11 μm; manufactured by Kyocera Corporation) was immersed in this slurry and was raised up out therefrom to form a coating which would become the intermediate layer and which comprised powdered alumina on the outside surface of the porous alumina tube, and this was dried to fabricate a porous alumina substrate.

Powdered phenolic resin was dissolved in tetrahydrofuran (THF) to make carbon film precursor solution. The porous alumina substrate was immersed in this solution and was raised up out therefrom at constant speed to form a phenolic resin coating on the surface thereof, and this was dried, and was thereafter subjected to heat treatment (first heat treatment) in the nitrogen atmosphere to fabricate a carbon film composite. As conditions employed during heat treatment, Table 1 shows the temperature rise rate from room temperature, the maximum temperature attained, and the holding time at maximum temperature. Thickness of the carbon film was controlled by varying the speed with which this raising up out from the carbon film precursor solution was carried out. Carbon film thicknesses obtained are shown in Table 1.

To evaluate separation characteristics of the carbon film composites that were fabricated, testing was conducted in which a solution containing a mixture of water and ethanol was subjected to pervaporative separation. Test conditions were such that a solution in which water and ethanol were mixed in the ratio 10/90 (mass %) was supplied thereto and temperature was 75° C. A GC-2014 Gas Chromatograph (Shimadzu Corporation) was used to measure ethanol content (mass %) and water content (mass %) at the feed side and at the permeate side, and the foregoing formulas were used to calculate separation factor α and permeation rate Q. Results are shown in Table 1.

An HR-800 Laser Raman Spectrometer (Horiba, Ltd.) was used to carry out Raman spectroscopy. Laser wavelength was 514.3 nm, and measurements were carried out at wave number values of 100 cm⁻¹ to 3250 cm⁻¹. Peak intensities of the G band (in the vicinity of 1590 cm⁻¹) and the D band (in the vicinity of 1350 cm⁻¹) in the spectrum obtained were recorded, and the ratio of the peak intensity of the D band to the peak intensity of the G band (D band peak intensity divided by G band peak intensity) was calculated to determine R value. The relationship between R value and separation factor α obtained is shown in FIG. 2. R value for each sample is shown in Table 1.

As shown in Table 1, at Sample Nos. 4 through 18, for which the R value (D band peak intensity divided by G band peak intensity) calculated from the Raman spectrum of the carbon film was not less than 0.840, it was possible to obtain a carbon film composite that exhibited a high separation factor α and a high permeation rate for separation of water and ethanol. Sample Nos. 8 through 16, for which the R value was within the range 0.870 to 0.915, it was possible to achieve particularly high separation factor α for separation of water and ethanol.

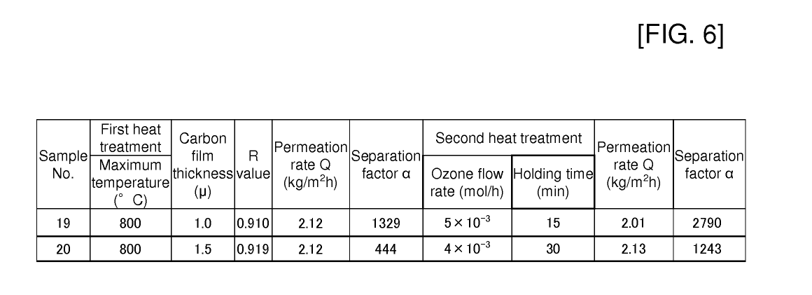

FIG. 6 is a Table 2 showing exemplary experimental results for evaluation of separation characteristics and Raman spectroscopy of a carbon film composites fabricated in accordance according to an embodiment of the disclosure.

Next, the carbon film composite was subjected to a second heat treatment, and the separation characteristics thereof were evaluated. The carbon film composites employed underwent first heat treatment by subjecting these to a temperature rise rate of 50° C./min from room temperature, heat treatment being carried out for a holding time of 10 minutes at the maximum temperature indicated in Table 2 shown in FIG. 6. Conditions were otherwise as described above. Evaluation of separation characteristics and Raman spectroscopy of the carbon film composites that were fabricated were carried out in accordance with the methods described above. Results are shown in Table 2.

The insides of the porous tubes at the carbon film composites A shown in Table 2 of FIG. 6 were made to come in contact with O₃ flowing therethrough for about 5 hours at room temperature, and second heat treatment was thereafter carried out in which the entire carbon film composites were made to undergo heat treatment at about 250° C. under atmospheric conditions in an electric kiln. Conditions under which O₃ was brought into contact therewith, and holding time at the maximum temperature of the second heat treatment, this being one of the conditions under which the second heat treatment was carried out, are shown in Table 2.

X-ray photoelectron spectroscopy (XPS) was carried out on the carbon film of the carbon film composites that underwent the second heat treatment, as a result of which presence of C—O bonds, i.e., presence of oxygen, was confirmed.

Separation characteristics of the carbon film composites that underwent the second heat treatment were evaluated in accordance with the method described above before and after the second heat treatment was carried out. Results are shown in Table 2.

For the carbon film composites that were subjected to the second heat treatment, it was possible to achieve further increase in separation factor α while maintaining high permeation rate Q. At Sample Nos. 19 and 20, a composite layer in which carbonaceous material was present at the interior of the intermediate layer had formed, and a higher oxygen content was detected at the carbonaceous material of the composite layer than at the carbon film.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A carbon film composite comprising:
a porous substrate; and
a carbon film on a surface of the porous substrate, having an R value of not less than about 0.840 wherein the R value is calculated from a Raman spectrum of the carbon film.

2. The carbon film composite according to claim 1, wherein the R value is within a range of about 0.860 to about 0.915.

3. The carbon film composite according to claim 2, wherein the R value is within a range of about 0.870 to about 0.915.

4. The carbon film composite according to claim 1, wherein the carbon film comprises an amorphous structure.

5. The carbon film composite according to claim 1, wherein the carbon film separates water and ethanol.

6. The carbon film composite according to claim 1, wherein oxygen is present at the carbon film.

7. The carbon film composite according to claim 6, wherein a content of the oxygen is greater at a side of the carbon film near the porous substrate than near a surface side of the carbon film.

8. A method for manufacturing a carbon film composite, the method comprising:
applying a carbon film precursor solution to a surface of a porous substrate to form a resultant substrate; and
subjecting the resultant substrate to a first heat treatment in a non-oxidizing environment, the first heat treatment comprising:
increasing a temperature at a temperature rise rate in a range of about 10° C./min to about 50° C./min to reach a maximum temperature in a range of about 750° C. to about 950° C.

9. The method according to claim 8, wherein the non-oxidizing environment comprises a vacuum condition.

10. The method according to claim 8, wherein the maximum temperature is in a range of about 800° C. to about 900° C.

11. The method according to claim 8, wherein the carbon film precursor solution comprises a solution in which phenolic resin is dissolved.

12. The method according to claim 8, further comprising:
making a surface at a porous substrate side of the carbon film composite in contact with a gas containing ozone (O₃); and
subjecting the carbon film composite to a second heat treatment under atmospheric conditions.

13. A separation membrane module comprising:
the carbon film composite according to claim 1, further comprising a carbon film side and a porous substrate side, and operable to separate a component having a molecular diameter which is small enough to permeate the carbon film from a mixed fluid supplied to the carbon film side;
a mixed fluid feed chamber operable to supply the mixed fluid to the carbon film side; and
a separated fluid chamber operable to receive a fluid comprising the component, going through the carbon film composite, and coming out of the porous substrate side.

14. The separation membrane module according to claim 13, wherein the mixed fluid comprises a gas comprising at least two components, and the fluid comprises a gas comprising concentrated at least one of the components.

15. The separation membrane module according to claim 13, wherein the mixed fluid comprises a liquid comprising at least two components, and the fluid comprises a liquid comprising concentrated at least one of the components.

16. The separation membrane module according to claim 13, further comprising a housing configured to house the carbon film composite.

17. The separation membrane module according to claim 16, wherein the mixed fluid feed chamber is arranged in an interior of the housing.

18. The separation membrane module according to claim 16, wherein the separated fluid chamber is arranged in an interior of the housing.
